(19) United States
(12) Patent Application Publication
(10) Pub. No.: US 2019/0371295 A1
(43) Pub. Date: Dec. 5, 2019

(54) SYSTEMS AND METHODS FOR SPEECH INFORMATION PROCESSING

(71) Applicant: BEIJING DIDI INFINITY TECHNOLOGY AND DEVELOPMENT CO., LTD., Beijing (CN)

(72) Inventors: Liqiang HE, Beijing (CN); Xiaohui LI, Beijing (CN); Guanglu WAN, Beijing (CN)

(73) Assignee: BEIJING DIDI INFINITY TECHNOLOGY AND DEVELOPMENT CO., LTD., Beijing (CN)

(21) Appl. No.: 16/542,325

(22) Filed: Aug. 16, 2019

Related U.S. Application Data
(63) Continuation of application No. PCT/CN2017/114415, filed on Dec. 4, 2017.

(30) Foreign Application Priority Data
Mar. 21, 2017 (CN) 201710170345.5

(51) Int. Cl. G10L 15/02; G10L 15/06; G10L 15/22

(52) U.S. Cl. CPC G10L 15/02; G10L 2015/228; G10L 15/22; G10L 15/063

(57) ABSTRACT

System and methods for generating user behaviors using a speech recognition method are provided. The method may include obtaining an audio file including speech data associated with one or more speakers and separating the audio file into one or more audio sub-files that each includes a plurality of speech segments. Each of the one or more audio sub-files may correspond to one of the one or more speakers. The method may further include obtaining time information and speaker identification information corresponding to each of the plurality of speech segments and converting the plurality of speech segments to a plurality of text segments. Each of the plurality of speech segments may correspond to one of the plurality of text segments. The method may further include generating first feature information based on the plurality of text segments, the time information, and the speaker identification information.

### CROSS-REFERENCE TO RELATED APPLICATIONS

This application is a continuation of International Application No. PCT/CN 2017/114415, filed on Dec. 4, 2017, which claims priority to Chinese Patent Application No. 201710170345.5, filed on Mar. 21, 2017. Each of the above-referenced applications is incorporated hereby by reference in their entireties.

### TECHNICAL FIELD

The present disclosure generally relates to speech information processing, and in particular, to methods and systems for processing speech information to generate user behaviors using a speech recognition method.

### BACKGROUND

Speech information processing (e.g., speech recognition method) has been widely used in daily lives. For online on-demand services, a user can simply provide his/her requirements by entering speech information into an electronic device, such a mobile phone. For example, a user (e.g., a passenger) may provide a service request in a form of speech data via a microphone of his/her terminal (e.g., a mobile phone). Accordingly, another user (e.g., a driver) may reply the service request in a form of speech data via a microphone of his/her terminal (e.g., a mobile phone). In some embodiments, the speech data associated with a speaker may reflect behaviors of the speaker and may be used to generate a user behavior model that bridges a connection between a speech file and user behaviors corresponding to the users in the speech file. However, a machine or a computer may not understand the speech data directly. Thus, it is desirable to provide a new speech information processing method for generating feature information that is suitable for training a user behavior model.

### SUMMARY

In one aspect of the present disclosure, a speech recognition system is provided. The speech recognition system may include a bus, at least one input port connected to the bus, one or more microphones connected to the input port, at least one storage device connected to the bus, and logic circuits in communication with the at least one storage device. Each of the one or more microphones may be configured to detect speech from at least one of the one or more speakers and generate speech data of the corresponding speaker to the input port. The at least one storage device may store a set of instructions for speech recognition. When executing the set of instructions, the logic circuits may be directed to obtain an audio file including the speech data associated with the one or more speakers and separate the audio file into one or more audio sub-files that each includes a plurality of speech segments. Each of the one or more audio sub-files may correspond to one of the one or more speakers. The logic circuits may be further directed to obtain time information and speaker identification information corresponding to each of the plurality of speech segments and convert the plurality of speech segments to a plurality of text segments. Each of the plurality of speech segments may correspond to one of the plurality of text segments. The logic circuits may be further directed to generate first feature information based on the plurality of text segments, the time information, and the speaker identification information.

In some embodiments, the one or more microphones may be mounted in at least one vehicle compartment.

In some embodiments, the audio file may be obtained from a single channel, and to separate the audio file into one or more audio sub-files, the logic circuits may be directed to perform a speech separation including at least one of a computational auditory scene analysis or a blind source separation.

In some embodiments, the time information corresponding to each of the plurality of speech segments may include a starting time and a duration time of the speech segment.

In some embodiments, the logic circuits may be further directed to obtain a preliminary model, obtain one or more user behaviors that each corresponds to one of the one or more speakers, and generate a user behavior model by training the preliminary model based on the one or more user behaviors and the generated first feature information.

In some embodiments, the logic circuits may be further directed to obtain second feature information, and execute the user behavior model based on the second feature information to generate one or more user behaviors.

In some embodiments, the logic circuits may be further directed to remove noise in the audio file before separating the audio file into one or more audio sub-files.

In some embodiments, the logic circuits may be further directed to remove noise in the one or more audio sub-files after separating the audio file into one or more audio sub-files.

In some embodiments, the logic circuits may be further directed to segment each of the plurality of text segments into words after converting each of the plurality of speech segments to a text segment.

In some embodiments, to generate the first feature information based on the plurality of text segments, the time information, and the speaker identification information, the logic circuits may be directed to sequence the plurality of text segments based on the time information of the text segments, and generate the first feature information by labelling each of the sequenced text segments with the corresponding speaker identification information.

In some embodiments, the logic circuits may be further directed to obtain location information of the one or more speakers, and generate the first feature information based on the plurality of text segments, the time information, the speaker identification information, and the location information

In another aspect of the present disclosure, a method is provided. The method may be implemented on a computing device having at least one storage device storing a set of instructions for speech recognition, and logic circuits in communication with the at least one storage device. The method may include obtaining an audio file including speech data associated with one or more speakers and separating the audio file into one or more audio sub-files that each includes a plurality of speech segments. Each of the one or more audio sub-files may correspond to one of the one or more speakers. The method may further include obtaining time information and speaker identification information corresponding to each of the plurality of speech segments and converting the plurality of speech segments to a plurality of text segments. Each of the plurality of speech segments may correspond to one of the plurality of text segments. The method may further include generating first feature information based on the plurality of text segments, the time information, and the speaker identification information.

In another aspect of the present disclosure, a non-transitory computer readable medium is provided. The non-transitory computer readable medium may include at least one set of instructions for speech recognition. When executed by logic circuits of an electronic terminal, the at least one set of instructions may direct the logic circuits to perform acts of obtaining an audio file including speech data associated with one or more speakers and separating the audio file into one or more audio sub-files that each includes a plurality of speech segments. Each of the one or more audio sub-files may correspond to one of the one or more speakers. The at least one set of instructions may further direct the logic circuits to perform acts of obtaining time information and speaker identification information corresponding to each of the plurality of speech segments and converting the plurality of speech segments to a plurality of text segments. Each of the plurality of speech segments may correspond to one of the plurality of text segments. The at least one set of instructions may further direct the logic circuits to perform acts of generating first feature information based on the plurality of text segments, the time information, and the speaker identification information.

In another aspect of the present disclosure, a system is provided. The system may be implemented on a computing device having at least one storage device storing a set of instructions for speech recognition, and logic circuits in communication with the at least one storage device. The system may include an audio file acquisition module, an audio file separation module, an information acquisition module, a speech conversion module, and a feature information generation module. The audio file acquisition module may be configured to obtain an audio file including speech data associated with one or more speakers. The information acquisition module may be configured to separate the audio file into one or more audio sub-files that each includes a plurality of speech segments. Each of the one or more audio sub-files may correspond to one of the one or more speakers. The information acquisition module may be configured to obtain time information and speaker identification information corresponding to each of the plurality of speech segments. The speech conversation module may be configured to convert the plurality of speech segments to a plurality of text segments. Each of the plurality of speech segments may correspond to one of the plurality of text segments. The feature information generation module may be configured to generate first feature information based on the plurality of text segments, the time information, and the speaker identification information.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a block diagram of an exemplary on-demand service system according to some embodiments of the present disclosure;

FIG. 2 is a schematic diagram illustrating exemplary hardware and/or software components of an exemplary computing device according to some embodiments of the present disclosure;

FIG. 3 is a schematic diagram illustrating an exemplary device according to some embodiments of the present disclosure;

FIG. 4 is a block diagram illustrating an exemplary processing engine according to some embodiments of the present disclosure;

FIG. 5 is a block diagram illustrating an exemplary audio file separation module according to some embodiments of the present disclosure;

FIG. 6 is a flowchart illustrating an exemplary process for generating feature information corresponding to a speech file according to some embodiments of the present disclosure;

FIG. 7 is a schematic diagram illustrating exemplary feature information corresponding to a dual-channel speech file according to some embodiments of the present disclosure;

FIG. 8 is a flowchart illustrating an exemplary process for generating feature information corresponding to a speech file according to some embodiments of the present disclosure;

FIG. 9 is a flowchart illustrating an exemplary process for generating feature information corresponding to a speech file according to some embodiments of the present disclosure;

FIG. 10 is a flowchart illustrating an exemplary process for generating a user behavior model according to some embodiments of the present disclosure; and

FIG. 11 is a flowchart illustrating an exemplary process for executing a user behavior model to generate user behaviors according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprises,” “comprising,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operations and functions of the related elements of structure and the combination of parts and economies of manufacture, may become more apparent upon consideration of the following description with reference to the accompanying drawing(s), all of which form part of this specification. It is to be expressly understood, however, that the drawing(s) are for the purpose of illustration and description only and are not intended to limit the scope of the present disclosure. It is understood that the drawings are not to scale.

The flowcharts used in the present disclosure illustrate operations that systems implement according to some embodiments of the present disclosure. It is to be expressly understood, the operations of the flowcharts may be implemented not in order. Conversely, the operations may be implemented in inverted order or simultaneously. Moreover, one or more other operations may be added to the flowcharts. One or more operations may be removed from the flowcharts.

Moreover, while the systems and methods disclosed in the present disclosure are described primarily regarding evaluating a user terminal, it should also be understood that this is only one exemplary embodiment. The system or method of the present disclosure may be applied to user of any other kind of on-demand service platform. For example, the system or method of the present disclosure may be applied to users in different transportation systems including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system that applies management and/or distribution, for example, a system for sending and/or receiving an express. The application scenarios of the system or method of the present disclosure may include a webpage, a plug-in of a browser, a client terminal, a custom system, an internal analysis system, an artificial intelligence robot, or the like, or any combination thereof.

The service starting points in the present disclosure may be acquired by positioning technology embedded in a wireless device (e.g., the passenger terminal, the driver terminal, etc.). The positioning technology used in the present disclosure may include a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning technologies may be used interchangeably in the present disclosure. For example, the GPS-based method and the WiFi-based method may be used together as positioning technologies to locate the wireless device.

An aspect of the present disclosure relates to systems and/or methods for speech information processing. The speech information processing may refer to generating feature information corresponding to a speech file. For example, a speech file may be recorded by a car-mounted recording system. The speech file may be a dual-channel speech file relating to a conversation between a passenger and a driver. The speech file may be separated into two speech sub-files, a sub-file A, and a sub-file B. The sub-file A may correspond to a passenger, and the sub-file B may correspond to a driver. For each of the plurality of speech segments, time information and speaker identification information corresponding to the speech segments may be obtained. The time information may include a starting time and/or a duration time (or a finishing time). The plurality of speech segments may be converted into a plurality of text segments. Then feature information corresponding to the dual-channel speech file may be generated based on the plurality of text segments, the time information, and the speaker identification information. The feature information generated may be further used for training a user behavior model.

It should be noted that the present solution relies on collecting usage data (e.g., speech data) of a user terminal registered with an online system, which is a new form of data collecting means rooted only in post-Internet era. It provides detailed information of a user terminal that could raise only in post-Internet era. In pre-Internet era, it is impossible to collect information of a user terminal such as speech data associated with traveling routes, departure locations, destinations, etc. Online on-demand service, however, allows the online platform to monitor millions of thousands of user terminals' behaviors in real-time and/or substantially real-time by analysis the speech data associated with drivers and passengers, and then provide better service scheme based on the behaviors and/or speech data of the user terminals. Therefore, the present solution is deeply rooted in and aimed to solve a problem only occurred in post-Internet era.

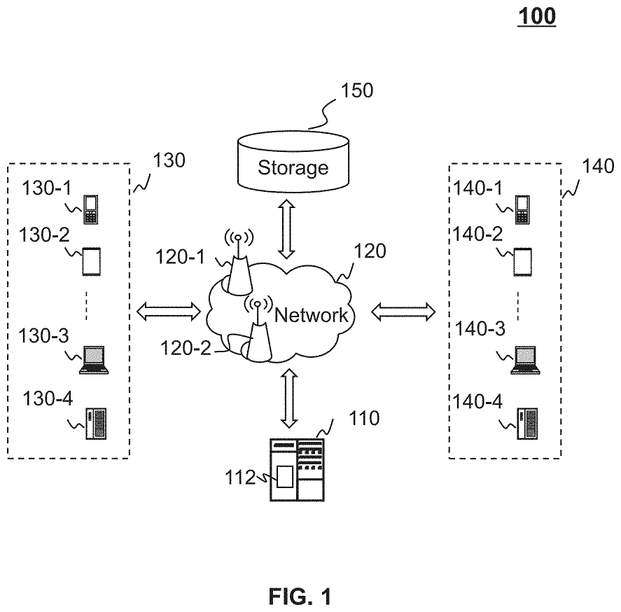

FIG. 1 is a block diagram of an exemplary on-demand service system according to some embodiments of the present disclosure. For example, the on-demand service system 100 may be an online transportation service platform for transportation services such as taxi hailing service, chauffeur service, express car service, carpool service, bus service, driver hire and shuttle service. The on-demand service system 100 may include a server 110, a network 120, a passenger terminal 130, a driver terminal 140, and a storage 150. The server 110 may include a processing engine 112.

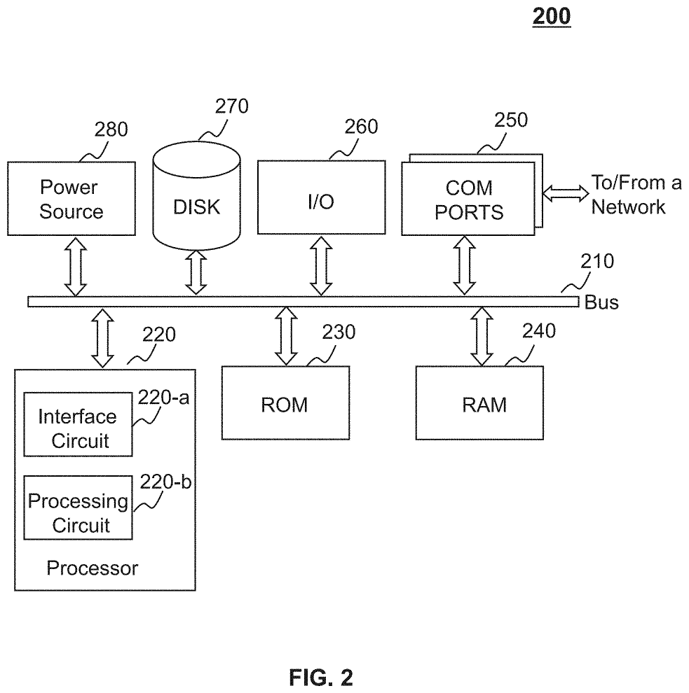

The server 110 may be configured to process information and/or data relating to a service request. For example, the server 110 may determine feature information based on a speech file. In some embodiments, the server 110 may be a single server, or a server group. The server group may be centralized, or distributed (e.g., the server 110 may be a distributed system). In some embodiments, the server 110 may be local or remote. For example, the server 110 may access information and/or data stored in the passenger terminal 130, the driver terminal 140, and/or the storage 150 via the network 120. As another example, the server 110 may be directly connected to the passenger terminal 130, the driver terminal 140, and/or the storage 150 to access information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device having one or more components illustrated in FIG. 2 in the present disclosure.

In some embodiments, the server 110 may include a processing engine 112. The processing engine 112 may process information and/or data relating to the service request to perform one or more functions of the server 110 described in the present disclosure. For example, the processing engine 112 may obtain an audio file. The audio file may be a speech file (also referred to as a first speech file) including speech data associated with a driver and a passenger (e.g., a conversation between them). The processing engine 112 may obtain the speech file from the passenger terminal 130 and/or the driver terminal 140. As another example, the processing engine 112 may be configured to determine feature information corresponding to the speech file. The generated feature information may be used for training a user behavior model. Then the processing engine 112 may input a new speech file (also referred to as a second speech file) into the trained user behavior model, and generate user behaviors corresponding to the speakers in the new speech file. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the on-demand service system 100 (e.g., the server 110, the passenger terminal 130, the driver terminal 140, and/or the storage 150) may transmit information and/or data to other component(s) in the on-demand service system 100 via the network 120. For example, the server 110 may obtain/acquire service request data from the passenger terminal 130 via the network 120. In some embodiments, the network 120 may be any type of wired or wireless network, or combination thereof. Merely by way of example, the network 120 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth™ network, a ZigBee™ network, a near field communication (NFC) network, a global system for mobile communications (GSM) network, a code-division multiple access (CDMA) network, a time-division multiple access (TDMA) network, a general packet radio service (CPRS) network, an enhanced data rate for GSM evolution (EDGE) network, a wideband code division multiple access (WCDMA) network, a high speed downlink packet access (HSDPA) network, a long term evolution (LTE) network, a user datagram protocol (UDP) network, a transmission control protocol/Internet protocol (TCP/IP) network, a short message service (SMS) network, a wireless application protocol (WAP) network, a ultra wide band (UWB) network, an infrared ray, or the like, or any combination thereof. In some embodiments, the server 110 may include one or more network access points. For example, the server 110 may include wired or wireless network access points such as base stations and/or Internet exchange points 120-1, 120-2, . . . , through which one or more components of the on-demand service system 100 may be connected to the network 120 to exchange data and/or information.

The passenger terminal 130 may be used by a passenger to request an on-demand service. For example, a user of the passenger terminal 130 may use the passenger terminal 130 to transmit a service request for himself/herself or another user, or receive service and/or information or instructions from the server 110. The driver terminal 140 may be used by a driver to reply an on-demand service. For example, a user of the driver terminal 140 may use the driver terminal 140 to receive a service request from the passenger terminal 130, and/or information or instructions from the server 110. In some embodiments, the term “user” and “passenger terminal” may be used interchangeably, and the term “user” and the “driver terminal” may be used interchangeably. In some embodiments, a user (e.g., a passenger) may initiate a service request in a form of speech data via a microphone of his/her terminal (e.g., the passenger terminal 130). Accordingly, another user (e.g., a driver) may reply the service request in a form of speech data via a microphone of his/her terminal (e.g., the driver terminal 140). The microphone of the driver (or the passenger) may be connected to the input port of his/her terminal.

In some embodiments, the passenger terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. In some embodiments, the passenger terminal 130 may be a wireless device with positioning technology for locating the position of the user and/or the passenger terminal 130.

In some embodiments, the driver terminal 140 may be similar to, or the same device as the passenger terminal 130. In some embodiments, the driver terminal 140 may be a wireless device with positioning technology for locating the position of the driver and/or the driver terminal 140. In some embodiments, the passenger terminal 130 and/or the driver terminal 140 may communicate with other positioning device to determine the position of the passenger, the passenger terminal 130, the driver, and/or the driver terminal 140. In some embodiments, the passenger terminal 130 and/or the driver terminal 140 may transmit positioning information to the server 110.

The storage 150 may store data and/or instructions. In some embodiments, the storage 150 may store data obtained/acquired from the passenger terminal 130 and/or the driver terminal 140. In some embodiments, the storage 150 may store data and/or instructions that the server 110 may execute or use to perform exemplary methods described in the present disclosure. In some embodiments, the storage 150 may include a mass storage, a removable storage, a volatile read-and-write memory, a read-only memory (ROM), or the like, or any combination thereof.

Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the storage 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 150 may be connected to the network 120 to communicate with one or more components in the on-demand service system 100 (e.g., the server 110, the passenger terminal 130, the driver terminal 140, etc.). One or more components in the on-demand service system 100 may access the data or instructions stored in the storage 150 via the network 120. In some embodiments, the storage 150 may be directly connected to or communicate with one or more components in the on demand service system 100 (e.g., the server 110, the passenger terminal 130, the driver terminal 140, etc.). In some embodiments, the storage 150 may be part of the server 110.

In some embodiments, one or more components in the on-demand service system 100 (e.g., the server 110, the passenger terminal 130, the driver terminal 140, etc.) may have a permission to access the storage 150. In some embodiments, one or more components in the on-demand service system 100 may read and/or modify information related to the passenger, driver, and/or the public when one or more conditions are met. For example, the server 110 may read and/or modify one or more users' information after a service. As another example, the driver terminal 140 may access information related to the passenger when receiving a service request from the passenger terminal 130, but the driver terminal 140 may not modify the relevant information of the passenger.

In some embodiments, information exchanging of one or more components in the on-demand service system 100 may be achieved by way of requesting a service. The object of the service request may be any product. In some embodiments, the product may be a tangible product, or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

One of ordinary skill in the art would understand that when an element of the on-demand service system 100 performs, the element may perform through electrical signals and/or electromagnetic signals. For example, when a passenger terminal 130 processes a task, such as inputting speech data, identifying or selecting an object, the passenger terminal 130 may operate logic circuits in its processor to perform such task. When the passenger terminal 130 transmits out a service request to the server 110, a processor of the server 110 may generate electrical signals encoding the request. The processor of the server 110 may then transmit the electrical signals to an output port. If the passenger terminal 130 communicates with the server 110 via a wired network, the output port may be physically connected to a cable, which further transmit the electrical signal to an input port of the server 110. If the passenger terminal 130 communicates with the server 110 via a wireless network, the output port of the service requester terminal 130 may be one or more antennas, which convert the electrical signal to electromagnetic signal. Similarly, a driver terminal 140 may process a task through operation of logic circuits in its processor, and receive an instruction and/or service request from the server 110 via electrical signal or electromagnet signals. Within an electronic device, such as the passenger terminal 130, the driver terminal 140, and/or the server 110, when a processor thereof processes an instruction, transmits out an instruction, and/or performs an action, the instruction and/or action is conducted via electrical signals. For example, when the processor retrieves or saves data from a storage medium, it may transmit out electrical signals to a read/write device of the storage medium, which may read or write structured data in the storage medium. The structured data may be transmitted to the processor in the form of electrical signals via a bus of the electronic device. Here, an electrical signal may refer to one electrical signal, a series of electrical signals, and/or a plurality of discrete electrical signals.

FIG. 2 is a schematic diagram illustrating exemplary hardware and software components of a computing device on which the server 110, the passenger terminal 130, and/or the driver terminal 140 may be implemented according to some embodiments of the present disclosure. For example, the processing engine 112 may be implemented on the computing device 200 and configured to perform functions of the processing engine 112 disclosed in the present disclosure.

The computing device 200 may be used to implement an on-demand system for the present disclosure. The computing device 200 may implement any component of the on-demand service as described herein. In FIG. 2, only one such computer device is shown purely for convenience purposes. One of ordinary skill in the art would understood at the time of filing of this application that the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processor 220, in the form of one or more processors, for executing program instructions. The exemplary computer platform may include an internal communication bus 210, a program storage and a data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, the RAM 240, and/or other type of non-transitory storage medium to be executed by the processor 220. The methods and/or processes of the present disclosure may be implemented as the program instructions. The computing device 200 may also include an I/O component 260, supporting input/output between the computer and other components therein, and a power source 280, providing power for the computing device 200 and/or the components therein. The computing device 200 may also receive programming and data via network communications.

The processor 220 (e.g., logic circuits) may execute computer instructions (e.g., program code) and perform functions of the processing engine 112 in accordance with techniques described herein. For example, the processor 220 may include interface circuits 220-a and processing circuits 220-b therein. The interface circuits 220-a may be configured to receive electronic signals from the bus 210, wherein the electronic signals encode structured data and/or instructions for the processing circuits 220-b to process. The processing circuits 220-b may conduct logic calculations, and then determine a conclusion, a result, and/or an instruction encoded as electronic signals. Then the interface circuits 220-a may send out the electronic signals from the processing circuits 220-b via the bus 210. In some embodiments, one or more microphones may be connected to the I/O component 260 or the input port thereof (not shown in FIG. 2). Each of the one or more microphones may be configured to detect speech from at least one of one or more speakers and generate speech data of the corresponding speaker to the I/O component 260 or the input port thereof.

Merely for illustration, only one processor 220 is described in the computing device 200. However, it should be noted that the computing device 200 in the present disclosure may also include multiple processors, thus operations and/or method steps that are performed by one processor 220 as described in the present disclosure may also be jointly or separately performed by the multiple processors. For example, if in the present disclosure the processor 220 of the computing device 200 executes both step A and step B, it should be understood that step A and step B may also be performed by two different processors jointly or separately in the computing device 200 (e.g., the first processor executes step A and the second processor executes step B, or the first and second processors jointly execute steps A and B).

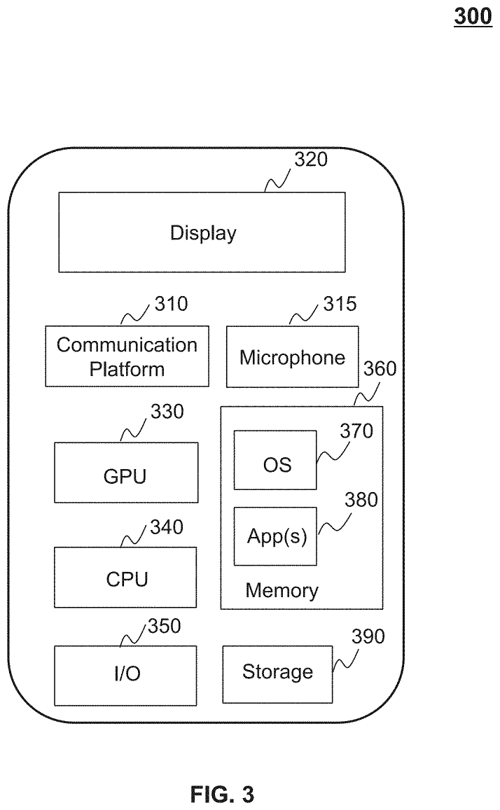

FIG. 3 is a schematic diagram illustrating exemplary hardware and/or software components of an exemplary device on which the passenger terminal 130 and/or the driver terminal 140 may be implemented according to some embodiments of the present disclosure. The device may be a mobile device, such as a mobile phone of a passenger or a driver. The device may also be an electronic device mounted on a vehicle driving by the driver. As illustrated in FIG. 3, the device 300 may include a communication platform 310, a display 320, a graphic processing unit (GPU) 330, a central processing unit (CPU) 340, an I/O 350, a memory 360, and a storage 390. In some embodiments, any other suitable component, including but not limited to a system bus or a controller (not shown), may also be included in the device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to an online on-demand service or other information from the server 110, and transmitting information relating to an online on-demand service or other information to the server 110. User interactions with the information stream may be achieved via the I/O 350 and provided to the server 110 and/or other components of the online on-demand service system 100 via the network 120. In some embodiments, the device 300 may include a device for capturing speech information, such as a microphone 315.

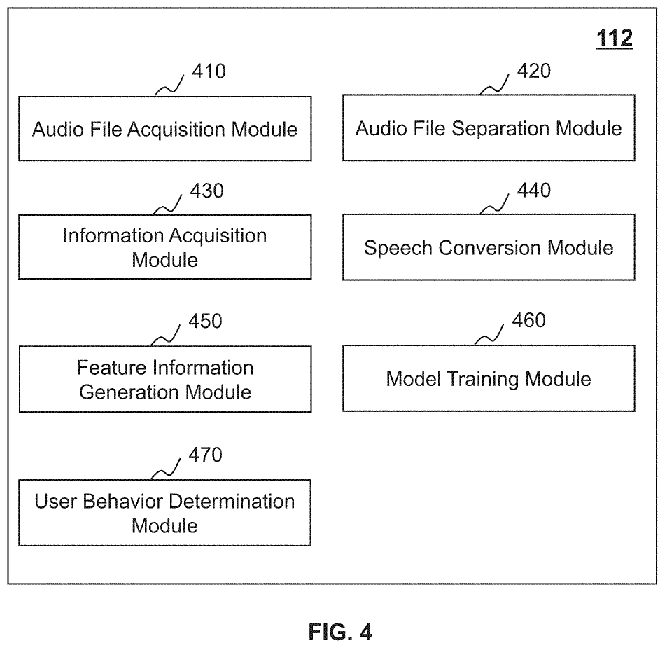

FIG. 4 is a block diagram illustrating an exemplary processing engine for generating feature information corresponding to a speech file according to some embodiments of the present disclosure. The processing engine 112 may be in communication with a storage (e.g., the storage 150, the passenger terminal 130, or the driver terminal 140), and may execute instructions stored in the storage medium. In some embodiments, the processing engine 112 may include an audio file acquisition module 410, an audio file separation module 420, an information acquisition module 430, a speech conversion module 440, a feature information generation module 450, a model training module 460, and a user behavior determination module 470.

The audio file acquisition module 410 may be configured to obtain an audio file. In some embodiments, the audio file may be a speech file including speech data associated with one or more speakers. In some embodiments, the one or more microphones may be mounted in at least one vehicle compartment (e.g., a taxi, a private car, a bus, a train, a bullet train, a high speed rail, a subway, a vessel, an aircraft, a spaceship, a hot-air balloon, a submarine) to detect speech from at least one of the one or more speakers and generate speech data of the corresponding speaker. For example, a position system (e.g., a Global Position System (GPS)) may be implemented on the at least one vehicle compartment or the one or more microphones mounted on it. The position system may obtain the location information of the vehicles (or the speakers therein). The location information may be relative locations (e.g., relative orientations and distances that the vehicles or speakers correspond to each other), or absolute locations (e.g., latitudes and longitudes). As another example, multiple microphones may be mounted in each of the vehicle compartment and the audio files (or the sound signals) recorded by multiple microphones may be integrated and/or compared with each other in magnitudes to obtain location information of the speakers in the vehicle compartment.

In some embodiments, the one or more microphones may be mounted in a shop, a road, or a house to detect speech from one or more speakers therein and generate speech data corresponding to the one or more speakers. In some embodiments, the one or more microphones may be mounted on a vehicle or an accessory of a vehicle (e.g., a motorcycle helmet). One or more motorcycle riders may talk to each other via the microphones mounted on their helmets. The microphones may detect speech from the motorcycle riders and generate speech data of the corresponding motorcycle riders. In some embodiments, each motorcycle may have a driver and one or more passengers that each wears a microphone-mounted motorcycle helmet. The microphones mounted on helmets of each motorcycle may be connected and microphones mounted on helmets of different motorcycles may also be interconnected. The connection between helmets may be established and terminated manually (e.g., by pressing buttons or setting parameters), or automatically (e.g., by establishing a Bluetooth™ connection automatically when two motorcycles are close to each other). In some embodiments, the one or more microphones may be mounted in a particular location to monitor the sounds (or voices) nearby. For example, the one or more microphones may be mounted in a reconstruction site to monitor the reconstruction noises and voices of the building workers.

In some embodiments, the speech file may be a multi-channel speech file. The multi-channel speech file may be obtained from multiple channels. Each of the multiple channels may include speech data associated with one of the one or more speakers. In some embodiments, the multi-channel speech file may be generated by a speech acquisition equipment with multiple channels, such as a telephone recording system. Each of the multiple channels may correspond to a user terminal (e.g., the passenger terminal 130, or the driver terminal 140). In some embodiments, the user terminals of all the speakers may collect speech data simultaneously, and may record time information related to the speech data. The user terminals of all the speakers may send the corresponding speech data to telephone recording system. The telephone recording system may then generate a multi-channel speech file based on the received speech data.

In some embodiments, the speech file may be a single-channel speech file. The single-channel speech file may be obtained from a single channel. Specifically, the speech data associated with one or more speakers may be collected by a speech acquisition equipment with only a channel, such as a car-mounted microphone, a road monitor, etc. For example, during a car hailing service, after a driver picks up a passenger, the car-mounted microphone may record a conversation between the driver and the passenger.

In some embodiments, the speech acquisition equipment may store a plurality of speech files generated in various scenarios. For a particular scenario, the audio file acquisition module 410 may select one or more corresponding speech files from the plurality of speech files. For example, during a car-hailing service, the audio file acquisition module 410 may select one or more speech files that contain words related to the car-hailing service, such as “plate number”, “departure location”, “destination”, “driving time”, etc., from the plurality of speech files. In some embodiments, the speech acquisition equipment may collect the speech data in a particular scenario. For example, the speech acquisition equipment (e.g., a telephone recording system) may be connected to a car-hailing application. The speech acquisition equipment may collect speech data associated with drivers and passengers when they're using the car-hailing applications. In some embodiments, the collected speech files (e.g., multi-channel speech files and/or single channel speech files) may be stored in the storage 150. The audio file acquisition module 410 may obtain the speech file from the storage 150.

The audio file separation module 420 may be configured to separate the speech file (or the audio file) into one or more speech sub-files (or audio sub-files). Each of the one or more speech sub-files may include a plurality of speech segments corresponding to one of one or more speakers.

For a multi-channel speech file, the speech data associated with each of one or more speakers may be distributed independently in one of the one or more channels. The audio file separation module 420 may separate the multi-channel speech file into one or more speech sub-files with respect to the one or more channels.

For a single channel speech file, the speech data associated with the one or more speakers may be collected into the single channel. The audio file separation module 420 may separate the single channel speech file into one or more speech sub-files by performing a speech separation. In some embodiments, the speech separation may include a blind source separation (BSS) method, a computational auditory scene analysis (CASA) method, etc.

In some embodiments, the speech conversion module 440 may first convert the speech file into a text file based on a speech recognition method. The speech recognition method may include but is not limited to a feature parameter matching algorithm, a hidden Markov model (HMM) algorithm, an artificial neural network (ANN) algorithm, etc. Then the separation module 420 may separate the text file into one or more text sub-files based on a semantic analyzing method. The semantic analyzing method may include a character matching-based word segmentation method (e.g., a maximum matching algorithm, an omni-word segmentation algorithm, a statistical language model algorithm), a sequence annotation-based word segmentation method (e.g., POS tagging), a deep learning-based word segmentation method (e.g., a hidden Markov model algorithm), etc. In some embodiments, each of the one or more text sub-files may correspond to one of the one or more speakers.

The information acquisition module 430 may be configured to obtain time information and speaker identification information corresponding to each of the plurality of speech segments. In some embodiments, the time information corresponding to each of the plurality of speech segments may include a starting time and/or a duration time (or a finishing time). In some embodiments, the starting time and/or the duration time may be absolute time (e.g., 1 min 20 s, 3 min 40 s) or relative time (e.g., 20% of the entire time length of the speech file). Specifically, the starting time and/or the duration time of the plurality of speech segments may reflect a sequence of the plurality of speech segments in the speech file. In some embodiments, the speaker identification information may be information that is able to distinguish between the one or more speakers. The speaker identification information may include names, ID numbers, or other information are unique for the one or more speakers. In some embodiments, the speech segments in each speech sub-file may correspond to a same speaker. The information acquisition module 430 may determine the speaker identification information of the speaker for the speech segments in each speech sub-file.

The speech conversion module 440 may be configured to convert the plurality of speech segments to a plurality of text segments. Each of the plurality of speech segments may correspond to one of the plurality of text segments. The speech conversion module 440 may convert the plurality of speech segments to the plurality of text segments based on a speech recognition method. In some embodiments, the speech recognition method may include a feature parameter matching algorithm, a hidden Markov model (HMM) algorithm, an artificial neural network (ANN) algorithm, or the like, or any combination thereof. In some embodiments, the speech conversion module 440 may convert the plurality of speech segments to the plurality of text segments based on isolated word recognition, keyword spotting, or continuous speech recognition. For example, the converted text segments may include words, phases, etc.

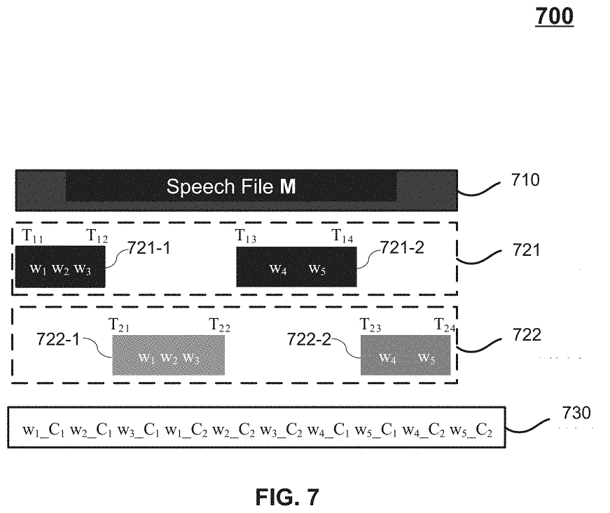

The feature information generation module 450 may be configured to generate feature information corresponding to the speech file based on the plurality of text segments, the time information, and the speaker identification information. The generated feature information may include the plurality of text segments and the speaker identification information (as shown in FIG. 7). In some embodiments, the feature information generation module 450 may sequence the plurality of text segments based on the time information of the text segments, and more specifically, based on the starting time of the text segments. The feature information generation module 450 may label each of the plurality of sequenced text segments with the corresponding speaker identification information. The feature information generation module 450 may then generate feature information corresponding to the speech file. In some embodiments, the feature information generation module 450 may sequence the plurality of text segments based on the speaker identification information of the one or more speakers. For example, if two speakers speak simultaneously, the feature information generation module 450 may sequence the plurality of text segments based on the speaker identification information of the two speakers.

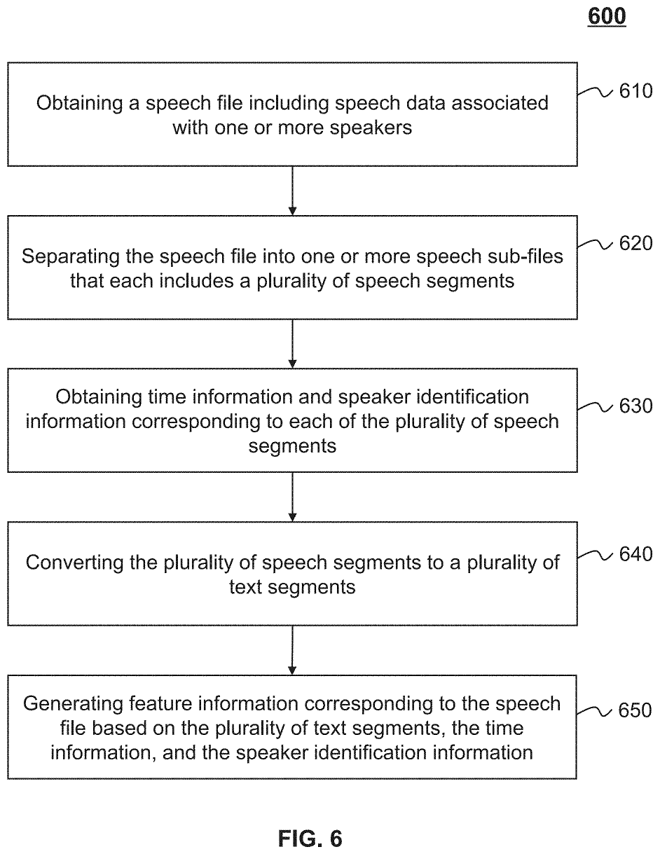

The model training module 460 may be configured to generate a user behavior model by training a preliminary model based on one or more user behaviors and feature information corresponding to a sample speech file. The feature information may include a plurality of text segments and speaker identification information of one or more speakers. The one or more user behaviors may be obtained by analyzing a speech file. The analysis of the speech file may be performed by a user or the system 100. For example, a user may listen to a speech file of a car hailing service and may determine one or more user behaviors as: “The driver was late for 20 mins” “the passenger had a big luggage with him” “it's snowy” “the driver usually drives fast”, etc. The one or more user behaviors may be obtained before training a preliminary model. Each of the one or more user behaviors may correspond to one of the one or more speakers. The plurality of text segments associated with a speaker may reflect the behavior of the speaker. For example, if the text segment associated with a driver is “Where are you going”, the behavior of the driver may include asking a passenger for a destination. As another example, if the text segment associated with a passenger is “Renmin Road”, the behavior of the passenger may include replying a driver's question. In some embodiments, the processor 220 may generate the feature information as described in FIG. 6 and send it to the model training module 460. In some embodiments, the model training module 460 may obtain the feature information from the storage 150. The feature information obtained from the storage 150 may be obtained from the processor 220 or may be obtained from an external device (e.g., a processing device). In some embodiments, the feature information and the one or more user behaviors may constitute a training sample.

The model training module 460 may be further configured to obtain a preliminary model. The preliminary model may include one or more classifiers. Each of the classifiers may have an initial parameter related to a weight of the classifier, and in training the preliminary model, the initial parameter of the classifiers may be updated. The preliminary model may take feature information as an input and may determine an internal output based on the feature information. The model training module 460 may take the one or more user behaviors as a desired output. The model training module 460 may train the preliminary model to minimize a loss function. In some embodiments, the model training module 460 may compare the internal output with the desired output in the loss function. For example, the internal output may correspond to an internal score, and the desired output may correspond to a desired score. The internal score and the desired score may be the same or different. The loss function may relate to a difference between the internal score and the desired score. Specifically, when the internal output is the same as the desired output, the internal score is the same as the desired score, and the loss function is at a minimum (e.g., zero). The loss function may include but is not limited to a zero-one loss, a perceptron loss, a hinge loss, a log loss, a square loss, an absolute loss, and an exponential loss. The minimization of the loss function may be iterative, The iteration of the minimization of the loss function may terminate when the value of the loss function is less than a predetermined threshold. The predetermined threshold may be set based on various factors, including the number of the training samples, the accuracy degree of the model, etc. The model training module 460 may iteratively adjust the initial parameters of the preliminary model during the minimization of the loss function. After minimizing the loss function, the initial parameters of the classifiers in the preliminary model may be updated and a trained user behavior model may be generated.

The user behavior determination module 470 may be configured to execute a user behavior model based on feature information corresponding to a speech file to generate one or more user behaviors. The feature information corresponding to the speech file may include a plurality of text segments and speaker identification information of the one or more speakers. In some embodiments, the processor 220 may generate the feature information as described in FIG. 6 and send it to the user behavior determination module 470. In some embodiments, the user behavior determination module 470 may obtain the feature information from the storage 150. The feature information obtained from the storage 150 may be obtained from the processor 220 or may be obtained from an external device (e.g., a processing device). The user behavior model may be trained by the model training module 460.

The user behavior determination module 470 may input the feature information into the user behavior model. The user behavior model may output one or more user behaviors based on the inputted feature information.

It should be noted that the above description of the processing engine for generating the feature information corresponding to a speech file is provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. For example, some of the modules may be installed in a different device separate from the other modules. Merely by way of example, the feature information generation module 450 may reside in a device, and other modules may reside in a different device. As another example, the audio file separation module 420 and the information acquisition module 430 may be integrated into one module, configured to separate the speech file into one or more speech sub-files that each includes a plurality of speech segments and obtain time information and speaker identification information corresponding to each of the plurality of speech segments.

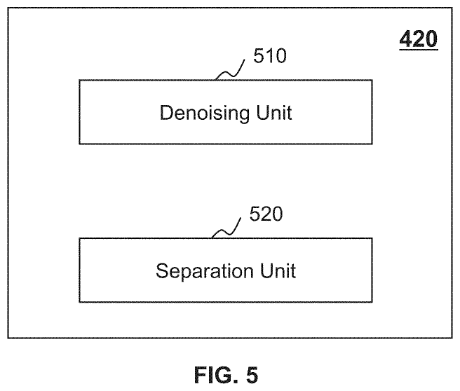

FIG. 5 is a block diagram illustrating an exemplary audio file separation module according to some embodiments of the present disclosure. The audio file separation module 420 may include a denoising unit 510, and a separation unit 520.

The denoising unit 510 may be configured to, before separating a speech file into one or more speech sub-files, remove noise in the speech file to generate a denoised speech file. The noise may be removed using a noise removing method, including but not limited to a voice activity detection (VAD). The VAD may remove noise in the speech file so that speech segments that remain in the speech files may be presented. In some embodiments, the VAD may further determine a starting time and/or a duration time (or a finishing time) for each of the speech segments.

In some embodiments, the denoising unit 510 may be configured to, after separating a speech file into one or more speech sub-files, remove noise in the one or more speech sub-files. The noise may be removed using a noise removing method, including but not limited to VAD. The VAD can remove noise in each of the one or more speech sub-files. The VAD may further determine a starting time and/or a duration time (or a finishing time) for each of the plurality of speech segments in each of the one or more speech sub-files.

The separation unit 520 may be configured to, after removing noise in a speech file, separate the denoised speech file into one or more denoised speech sub-files. For a multi-channel denoised speech file, the separation unit 520 may separate the multi-channel denoised speech file into one or more denoised speech sub-files with respect to the channels. For a single channel denoised speech file, the separation unit 520 may separate the single channel denoised speech file into one or more denoised speech sub-files by performing a speech separation.

In some embodiments, the separation unit 520 may be configured to, before removing noise in a speech file, separate the speech fine into one or more speech sub-files. For a multi-channel speech file, the separation unit 520 may separate the multi-channel speech file into one or more speech sub-files with respect to the channels. For a single channel speech file, the separation unit 520 may separate the single channel speech file into one or more speech sub-files by performing a speech separation.

FIG. 6 is a flowchart illustrating an exemplary process for generating feature information corresponding to a speech file according to some embodiments of the present disclosure. In some embodiments, the process 600 may be implemented in the on-demand service system 100 as illustrated in FIG. 1. For example, the process 600 may be stored in the storage 150 and/or other storage (e.g., the ROM 230, the RAM 240) as a form of instructions, and invoked and/or executed by the server 110 (e.g., the processing engine 112 in the server 110, the processor 220 of the processing engine 112 in the server 110, the logic circuits of the server 110, and/or a corresponding module of the server 110). The present disclosure takes the modules of the server 110 as an example to execute the instruction.

In step 610, the audio file acquisition module 410 may obtain an audio file. In some embodiments, the audio file may be a speech file including speech data associated with one or more speakers. In some embodiments, the one or more microphones may be mounted in at least one vehicle compartment (e.g., a taxi, a private car, a bus, a train, a bullet train, a high speed rail, a subway, a vessel, an aircraft, a spaceship, a hot-air balloon, a submarine) to detect speech from at least one of the one or more speakers and generate speech data of the corresponding speaker. For example, if a microphone is mounted in a car (also referred to as a car-mounted microphone), the microphone may record speech data of speakers in the car (e.g., a driver and a passenger). In some embodiments, the one or more microphones may be mounted in a shop, a road, or a house to detect speech from one or more speakers therein and generate speech data corresponding to the one or more speakers. For example, if a customer shops in a shop, a microphone in the shop may record speech data between the customer and a salesclerk. As another example, if one or more travelers visit a scenic spot, the talks between them may be detected by microphones mounted in the scenic spot. Then the microphones may generate speech data associated with the travelers. The speech data may be used for analyzing behaviors of travelers and their attitudes towards the scenic spot. In some embodiments, the one or more microphones may be mounted on a vehicle or an accessory of a vehicle (e.g., a motorcycle helmet). For example, motorcycle riders may talk to each other via the microphones mounted on their helmets. The microphones may record talks between the motorcycle riders and generate speech data of the corresponding motorcycle riders. In some embodiments, the one or more microphones may be mounted in a particular location to monitor the sounds (or voices) nearby. For example, the one or more microphones may be mounted in a reconstruction site to monitor the reconstruction noises and voices of the building workers. As another example, if the microphones is mounted in a house, the microphones may detect speech between the family members and generate speech data related to the family members. The speech data may be used for analyzing habits of the family members. In some embodiments, the microphones may detect non-human sound in the house, such as, sound of a vehicle, a pet, etc.

In some embodiments, the speech file may be a multi-channel speech file. The multi-channel speech file may be obtained from multiple channels. Each of the multiple channels may include speech data associated with one of the one or more speakers. In some embodiments, the multi-channel speech file may be generated by a speech acquisition equipment with multiple channels, such as a telephone recording system. For example, if two speakers a speaker A and a speaker B have a phone call with each other, the speech data associated with speaker A and speaker B may be collected by the mobile phone of speaker A and the mobile phone of speaker B, respectively. The speech data associated with speaker A may be sent to a channel of the telephone recording system, and the speech data associated with speaker B may be sent to another channel of the telephone recording system. A multi-channel speech file including speech data associated with speaker A and speaker B may be generated by the telephone recording system. In some embodiments, the speech acquisition equipment may store a plurality of multi-channel speech files generated in various scenarios. For a particular scenario, the audio file acquisition module 410 may select one or more corresponding multi-channel speech files from the plurality of multi-channel speech files. For example, during a car-hailing service, the audio file acquisition module 410 may select one or more multi-channel speech files that contain words related to the car-hailing service, such as “license plate number”, “departure location”, “destination”, “driving time”, etc., from the plurality of multi-channel speech files. In some embodiments, the speech acquisition equipment (e.g., a telephone recording system) may be used in a particular scenario. For example, the telephone recording system may be connected to a car-hailing application. Then the telephone recording system may collect speech data associated with drivers and passengers when they're using the car-hailing applications.

In some embodiments, the speech file may be a single channel speech file. The single channel speech file may be obtained from a single channel. Specifically, the speech data associated with one or more speakers may be collected by a speech acquisition equipment with a single channel, such as a car-mounted microphone, a road monitor, etc. For example, during a car-hailing service, when a driver picks up a passenger, the car-mounted microphone may record a conversation between the driver and the passenger. In some embodiments, the speech acquisition equipment may store a plurality of single channel speech files generated in various scenarios. For a particular scenario, the audio file acquisition module 410 may select one or more corresponding single channel speech files from the plurality of single channel speech files. For example, during a car-hailing service, the audio file acquisition module 410 may select one or more single channel speech files that contain words related to the car-hailing service, such as “license plate number”, “departure location”, “destination”, “driving time”, etc., from the plurality of single channel speech files. In some embodiments, the speech acquisition equipment (e.g., a car-mounted microphone) may collect the speech data in a particular scenario. For example, a microphone may be mounted in cars of drivers that have registered on a car-hailing application. The car-mounted microphone may record speech data associated with the drivers and passengers when they're using the car-hailing application.

In some embodiments, the collected speech file (e.g., multi-channel speech files and/or single channel speech files) may be stored in the storage 150. The audio file acquisition module 410 may obtain the speech file from the storage 150 or a storage of the speech acquisition equipment.

In step 620, the audio file separation module 420 may separate the speech file (or the audio file) into one or more speech sub-files (or audio sub-files) that each includes a plurality of speech segments. Each of the one or more speech sub-files may correspond to one of the one or more speakers. For example, a speech file may include speech data associated with three speakers (e.g., speaker A, speaker B, and speaker C). The audio file separation module 420 may separate the speech file into three speech sub-files (e.g., sub-file A, sub-file B, and sub-file C). Sub-file A may include a plurality of speech segments associated with speaker A; sub-file B may include a plurality of speech segments associated with speaker B; and sub-file C may include a plurality of speech segments associated with speaker C.

For a multi-channel speech file, the speech data associated with each of one or more speakers may be distributed independently in one of the one or more channels. The audio file separation module 420 may separate the multi-channel speech file into one or more speech sub-files with respect to the one or more channels.

For a single channel speech file, the speech data associated with the one or more speakers may be collected into the single channel. The audio file separation module 420 may separate the single channel speech file into one or more speech sub-files by performing a speech separation. In some embodiments, the speech separation may include a blind source separation (BSS) method, a computational auditory scene analysis (CASA) method, etc. The BSS is a process of recovering the independent components of source signal only based on observed signal data without knowing the source signal and parameters of the transmission channel. The BSS method may include an independent component analysis (ICA)-based BBS method, a signal sparseness-based BSS method, etc. The CASA is a process of separating mixed speech data into physical sound sources based on a model established using human auditory perception. The CASA may include a data-driven CASA, a schema-driven CASA, etc.

In some embodiments, the speech conversion module 440 may first convert the speech file into a text file based on a speech recognition method. The speech recognition method may include but is not limited to a feature parameter matching algorithm, a hidden Markov model (HMM) algorithm, an artificial neural network (ANN) algorithm, etc. Then the separation module 420 may separate the text file into one or more text sub-files based on a semantic analyzing method. The semantic analyzing method may include a character matching-based word segmentation method (e.g., a maximum matching algorithm, an omni-word segmentation algorithm, a statistical language model algorithm), a sequence annotation-based word segmentation method (e.g., POS tagging), a deep learning-based word segmentation method (e.g., a hidden Markov model algorithm), etc. In some embodiments, each of the one or more text sub-files may correspond to one of the one or more speakers.

In step 630, the information acquisition module 430 may obtain time information and speaker identification information corresponding to each of the plurality of speech segments. In some embodiments, the time information corresponding to each of the plurality of speech segments may include a starting time and/or a duration time (or a finishing time). In some embodiments, the starting time and/or the duration time may be absolute time (e.g., 1 min 20 s) or relative time (e.g., 20% of the entire time length of the speech file). Specifically, the starting time and/or the duration time of the plurality of speech segments may reflect a sequence of the plurality of speech segments in the speech file. In some embodiments, the speaker identification information may be information that is able to distinguish between the one or more speakers. The speaker identification information may include names, ID numbers, or other information that are unique for the one or more speakers. In some embodiments, the speech segments in each speech sub-file may correspond to a same speaker (e.g., sub-file A corresponding to speaker A). The information acquisition module 430 may determine the speaker identification information of the speaker for the speech segments in each speech sub-file.

In step 640, the speech conversion module 440 may convert the plurality of speech segments to a plurality of text segments. Each of the plurality of speech segments may correspond to one of the plurality of text segments. The speech conversion module 440 may convert the plurality of speech segments to the plurality of text segments based on a speech recognition method. The speech recognition method may include a feature parameter matching algorithm, a hidden Markov model (HMM) algorithm, an artificial neural network (ANN) algorithm, or the like, or any combination thereof. The feature parameter matching algorithm may include comparing feature parameters of speech data to be recognized with feature parameters of speech data in a speech template. For example, the speech conversion module 440 may compare feature parameters of the plurality of speech segments in a speech file with feature parameters of speech data in the speech template. The speech conversion module 440 may convert the plurality of speech segments to the plurality of text segments based on the comparison. The HMM algorithm can determine implicit parameters of a process from the observable parameters, and use the implicit parameters to convert the plurality of speech segments to the plurality of text segments. The speech conversion module 440 may convert the plurality of speech segments to the plurality of text segments precisely based on the ANN algorithm. In some embodiments, the speech conversion module 440 may convert the plurality of speech segments to the plurality of text segments based on isolated word recognition, keyword spotting, or continuous speech recognition. For example, the converted text segments may include words, phases, etc.

In step 650, the feature information generation module 450 may generate feature information corresponding to the speech file based on the plurality of text segments, the time information, and the speaker identification information. The generated feature information may include the plurality of text segments and the speaker identification information (as shown in FIG. 7). In some embodiments, the feature information generation module 450 may sequence the plurality of text segments based on the time information of the text segments, and more specifically, based on the starting time of the text segments. The feature information generation module 450 may label each of the plurality of sequenced text segments with the corresponding speaker identification information. The feature information generation module 450 may then generate feature information corresponding to the speech file. In some embodiments, the feature information generation module 450 may sequence the plurality of text segments based on the speaker identification information of the one or more speakers. For example, if two speakers speak simultaneously, the feature information generation module 450 may sequence the plurality of text segments based on the speaker identification information of the two speakers.

It should be noted that the above description of the process for determining the feature information corresponding to the speech file is provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. In some embodiments, after converting the plurality of speech segments to the plurality of text segments, each of the plurality of text segments may be segmented into words or phrases.

FIG. 7 is a schematic diagram illustrating exemplary feature information corresponding to a dual-channel speech file according to some embodiments of the present disclosure. As shown in FIG. 7, the speech file is a dual-channel speech file M including speech data associated with speaker A and speaker B. The audio file separation module 420 may separate the dual-channel speech file M into two speech sub-files that each includes a plurality of speech segments (not shown in FIG. 7). The speech conversion module 440 may convert the plurality of speech segments to a plurality of text segments. The two speech sub-files may correspond to two text sub-files (e.g., text sub-file 721 and text sub-file 722), respectively. As shown in FIG. 7, the text sub-file 721 includes two text segments (e.g., a first text segment 721-1 and a second text segment 721-2) associated with speaker A. T₁₁ and T₁₂ are the starting time and the finishing time of the first text segment 721-1, and T₁₃ and T₁₄ are the starting time and the finishing time of the second text segment 721-2. Similarly, text sub-file 722 includes two text segments (e.g., a third text segment 722-1 and a forth text segment 722-2) associated with speaker B. In some embodiments, the text segments may be segmented into words. For example, the first text segment is segmented into three words (e.g., w₁, w₂ and w₃). The speaker identification information C₁ may represent speaker A, and the speaker identification information C₂ may represent speaker B. The feature information generation module 450 may sequence the text segments (e.g., the first text segment 721-1, the second text segment 721-2, the third text segment 722-1 and the forth text segment 722-2) in the two text sub-files based on the starting time of the text segments (e.g., T₁₁, T₂₁, T₁₃ and T₂₃). The feature information generation module 450 may then generate feature information corresponding to the dual-channel speech file M by labelling each of the sequenced text segments with the corresponding speak identification information (e.g., C₁ or C₂). The feature information generated may be expressed as “w₁_C₁ w₂_C₁ w₁_C₂ w₂_C₂ w₃_C₂ w₄_C₁ w₅_C₁ w₄_C₂ w₅_C₂”.

Table 1 and Table 2 show exemplary text information (i.e., text segments) and time information associated with speaker A and speaker B. The feature information generation module 450 may sequence the text information based on the time information. Then the feature information generation module 450 may label the sequenced text information with corresponding speaker identification information. The speaker identification information C₁ may represent speaker A, and the speaker identification information C₂ may represent speaker B. The generated feature information may be expressed as “today_C₁ weather_C₁ yes_C₂ today_C₂ weather_C₂ fine_C₂ go_C₁ travelling_C₁ ok_C₂”.

TABLE 1

| Speaker | Text Information | Time Information |
|---|---|---|
| Speaker A | “today” “weather” “fine” | [1.02 s, 3.46 s] |
| | “go” “travelling” | [8.63 s, 10.86 s] |

TABLE 2

| Speaker | Text Information | Time Information |
|---|---|---|
| Speaker B | “yes” “today” “weather” “fine” | [4.02 s, 7.50 s] |
| | “ok” | [11.02 s, 14.56 s] |

It should be noted that the above description of generating feature information corresponding to the dual-channel speech file is provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. In the embodiment, the text segments are segmented into words. In other embodiments, the text segments may be segmented into characters, or phases.

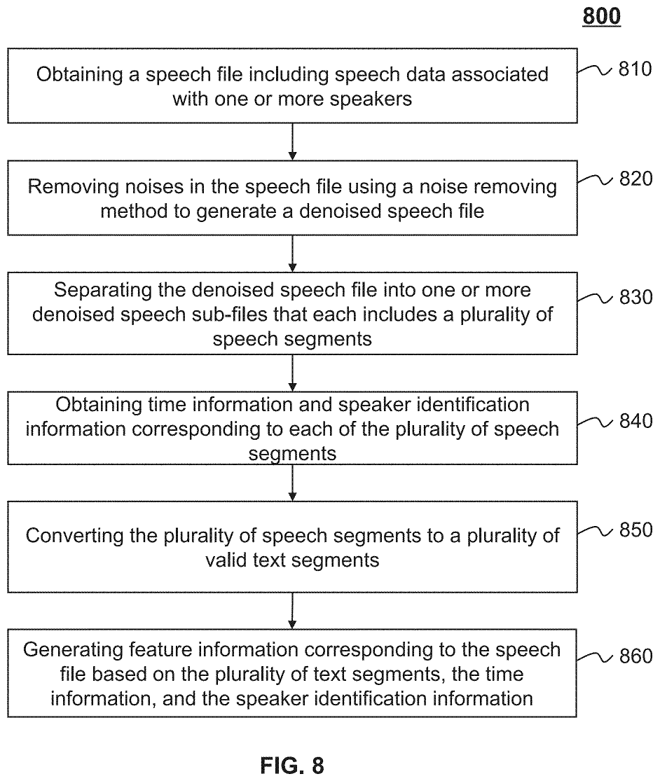

FIG. 8 is a flowchart illustrating an exemplary process for generating feature information corresponding to a speech file according to some embodiments of the present disclosure. In some embodiments, the process 800 may be implemented in the on-demand service system 100 as illustrated in FIG. 1. For example, the process 800 may be stored in the storage 150 and/or other storage (e.g., the ROM 230, the RAM 240) as a form of instructions, and invoked and/or executed by the server 110 (e.g., the processing engine 112 in the server 110, the processor 220 of the processing engine 112 in the server 110, the logic circuits of the server 110, and/or a corresponding module of the server 110). The present disclosure takes the modules of the server 110 as an example to execute the instruction.

In step 810, the audio file acquisition module 410 may obtain a speech file including speech data associated with one or more speakers. In some embodiments, the speech file may be a multi-channel speech file obtained from multiple channels. Each of the multiple channels may include speech data associated with one of the one or more speakers. In some embodiments, the speech file may be a single channel speech file obtained from a single channel. The speech data associated with the one more speakers may be collected into the single channel speech file. The acquisition of the speech file is described in connection with FIG. 6, and is not repeated here.

In step 820, the audio file separation module 420 (e.g., the denoising unit 510) may remove noise in the speech file to generate a denoised speech file. The noise may be removed using a noise removing method, including but not limited to voice activity detection (VAD). The VAD may remove noise in the speech file so that speech segments that remain in the speech files may be presented. The VAD may further determine a starting time and/or a duration time (or a finishing time) for each of the speech segments. Thus, the denoised speech file may include speech segments associated with the one or more speakers, time information of the speech segments, etc.

In step 830, the audio file separation module 420 (e.g., the separation unit 520) may separate the denoised speech file into one or more denoised speech sub-files. Each of the one or more denoised speech sub-files may include a plurality of speech segments associated with one of the one or more speakers. For a multi-channel denoised speech file, the separation unit 520 may separate the multi-channel denoised speech file into one or more denoised speech sub-files with respect to the channels. For a single channel denoised speech file, the separation unit 520 may separate the single channel denoised speech file into one or more denoised speech sub-files by performing a speech separation. The speech separation is described in connection with FIG. 6, and is not repeated here.

In step 840, the information acquisition module 430 may obtain time information and speaker identification information corresponding to each of the plurality of speech segments. In some embodiments, the time information corresponding to each of the plurality of speech segments may include a starting time and/or a duration time (or a finishing time). In some embodiments, the starting time and/or the duration time may be absolute time (e.g., 1 min 20 s) or relative time (e.g., 20% of the entire time length of the speech file). The speaker identification information may be information that is able to distinguish between the one or more speakers. The speaker identification information may include names, ID numbers, or other information that are unique for the one or more speakers. The acquisition of the time information and the speaker identification information is described in connection with FIG. 6, and is not repeated here.

In step 850, the speech conversion module 440 may convert the plurality of speech segments to a plurality of text segments. Each of the plurality of speech segments may correspond to one of the plurality of text segments. The conversion is described in connection with FIG. 6, and is not repeated here.

In step 860, the feature information generation module 450 may generate feature information corresponding to the speech file based on the plurality of text segments, the time information, and the speaker identification information. The generated feature information may include the plurality of text segments and the speaker identification information (as shown in FIG. 7). The generation of the feature information is described in connection with FIG. 6, and is not repeated here.

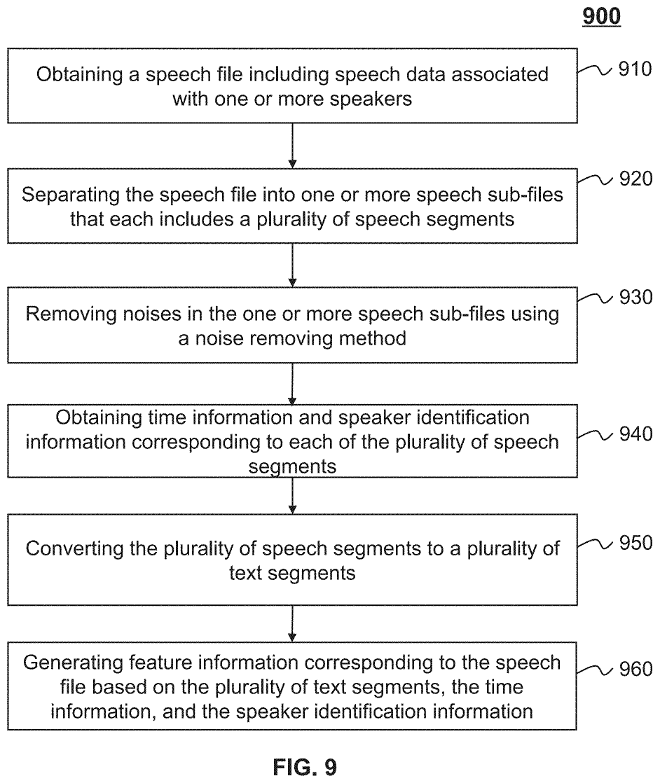

FIG. 9 is a flowchart illustrating an exemplary process for generating feature information corresponding to a speech file according to some embodiments of the present disclosure. In some embodiments, the process 900 may be implemented in the on-demand service system 100 as illustrated in FIG. 1. For example, the process 900 may be stored in the storage 150 and/or other storage (e.g., the ROM 230, the RAM 240) as a form of instructions, and invoked and/or executed by the server 110 (e.g., the processing engine 112 in the server 110, the processor 220 of the processing engine 112 in the server 110, the logic circuits of the server 110, and/or a corresponding module of the server 110). The present disclosure takes the modules of the server 110 as an example to execute the instruction.

In step 910, the audio file acquisition module 410 may obtain a speech file including speech data associated with one or more speakers. In some embodiments, the speech file may be a multi-channel speech file obtained from multiple channels. Each of the multiple channels may include speech data associated with one of the one or more speakers. In some embodiments, the speech file may be a single channel speech file obtained from a single channel. The speech data associated with the one more speakers may be collected into the single channel speech file. The acquisition of the speech file is described in connection with FIG. 6, and is not repeated here.

In step 920, the audio file separation module 420 (e.g., the separation unit 520) may separate the speech file into one or more speech sub-files. Each of the one or more speech sub-files may include a plurality of speech segments associated with one of the one or more speakers. For a multi-channel speech file, the separation unit 520 may separate the multi-channel speech file into one or more speech sub-files with respect to the channels. For a single channel speech file, the separation unit 520 may separate the single channel speech file into one or more speech sub-files by performing a speech separation. The speech separation is described in connection with FIG. 6, and is not repeated here.

In step 930, the audio file separation module 420 (e.g., the denoising unit 510) may remove noise in the one or more speech sub-files. The noise may be removed using a noise removing method, including but is not limited to voice activity detection (VAD). The VAD can remove noise in each of the one or more speech sub-files. The VAD may further determine a starting time and/or a duration time (or a finishing time) for each of the plurality of speech segments in each of the one or more speech sub-files.

In step 940, the information acquisition module 430 may obtain time information and speaker identification information corresponding to each of the plurality of speech segments. In some embodiments, the time information corresponding to each of the plurality of speech segments may include a starting time and/or a duration time (or a finishing time). In some embodiments, the starting time and/or the duration time may be absolute time (e.g., 1 min 20 s) or relative time (e.g., 20% of the entire time length of the speech file). The speaker identification information may be information that is able to distinguish between the one or more speakers. The speaker identification information may include names, ID numbers, or other information that are unique for the one or more speakers. The acquisition of the time information and the speaker identification information is described in connection with FIG. 6, and is not repeated here.

In step 950, the speech conversion module 440 may convert the plurality of speech segments to a plurality of text segments. Each of the plurality of speech segments may correspond to one of the plurality of text segments. The conversion is described in connection with FIG. 6, and is not repeated here.

In step 960, the feature information generation module 450 may generate feature information corresponding to the speech file based on the plurality of text segments, the time information, and the speaker identification information. The generated feature information may include the plurality of text segments and the speaker identification information (as shown in FIG. 7). The generation of the feature information is described in connection with FIG. 6, and is not repeated here.

It should be noted that the above description of the process for generating the feature information corresponding to the speech file is provided for the purposes of illustration, and is not intended to limit the scope of the present disclosure. For persons having ordinary skills in the art, multiple variations and modifications may be made under the teachings of the present disclosure. However, those variations and modifications do not depart from the scope of the present disclosure. For example, some steps in the process may be performed in sequence or simultaneously. As another example, some steps in the process may be decomposed into more than one step.

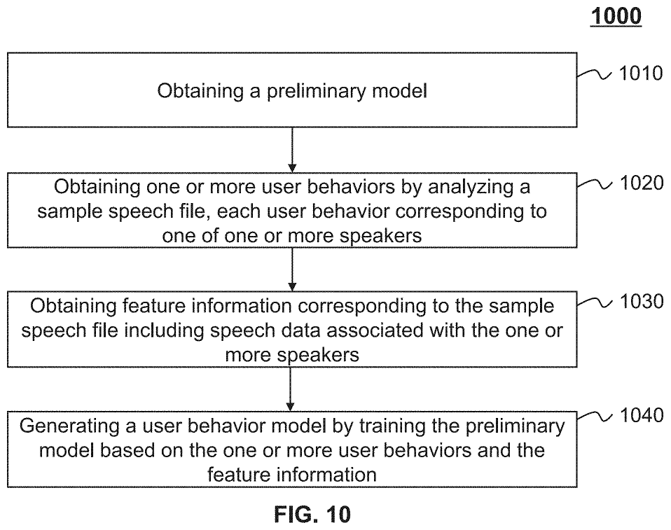

FIG. 10 is a flowchart illustrating an exemplary process for generating a user behavior model according to some embodiments of the present disclosure. In some embodiments, the process 1000 may be implemented in the on-demand service system 100 as illustrated in FIG. 1. For example, the process 1000 may be stored in the storage 150 and/or other storage (e.g., the ROM 230, the RAM 240) as a form of instructions, and invoked and/or executed by the server 110 (e.g., the processing engine 112 in the server 110, the processor 220 of the processing engine 112 in the server 110, the logic circuits of the server 110, and/or a corresponding module of the server 110). The present disclosure takes the modules of the server 110 as an example to execute the instruction.

In step 1010, the model training module 460 may obtain a preliminary model. In some embodiments, the preliminary model may include one or more classifiers. Each of the classifiers may have an initial parameter related to a weight of the classifier.

The preliminary model may include a Ranking Support Vector Machine (SVM) model, a Gradient Boosting Decision Tree (GBDT) model, a LambdaMART model, an adaptive boosting model, a recurrent neural network model, a convolutional network model, a hidden Markov model, a perceptron neural network model, a Hopfield network model, a self-organizing map (SOM), or a learning vector quantization (LVQ), or the like, or any combination thereof. The recurrent neural network model may include a long short term memory (LSTM) neural network model, a hierarchical recurrent neural network model, a bi-direction recurrent neural network model, a second-order recurrent neural network model, a fully recurrent network model, an echo state network model, a multiple timescales recurrent neural network (MTRNN) model, etc.

In step 1020, the model training module 460 may obtain one or more user behaviors that each corresponds to one of one or more speakers. The one or more user behaviors may be obtained by analyzing a sample speech file of the one or more speakers. In some embodiments, the one or more user behaviors may be related to particular scenarios. For example, during a car-hailing service, the one or more user behaviors may include behavior associated with a driver, behavior associated with a passenger, etc. For the driver, the behavior may include asking the passenger for the departure location, the destination, etc. For the passenger, the behavior may include asking the driver for the arrival time, the license plate number, etc. As another example, during a shopping service, the one or more user behaviors may include behavior associated with a salesman, behavior associated with a customer, etc. For the salesman, the behavior may include asking the customer for the product that he/her is looking for, the payment method, etc. For the customer, the behavior may include asking the salesman for prices, methods of use, etc. In some embodiments, the model training module 460 may obtain the one or more user behavior from the storage 150.

In step 1030, the model training module 460 may obtain feature information corresponding to the sample speech file. The feature information may correspond to the one or more user behaviors associated with the one or more speakers. The feature information corresponding to the sample speech file may include a plurality of text segments and speaker identification information of the one or more speakers. The plurality of text segments associated with a speaker can reflect the behavior of the speaker. For example, if the text segment associated with a driver is “Where are you going”, the behavior of the driver may include asking a passenger for a destination. As another example, if the text segment associated with a passenger is “Renmin Road”, the behavior of the passenger may include replying a driver's question. In some embodiments, the processor 220 may generate the feature information corresponding to the sample speech file as described in FIG. 6 and send it to the model training model 460. In some embodiments, the model training module 460 may obtain the feature information from the storage 150. The feature information obtained from the storage 150 may be obtained from the processor 220 or may be obtained from an external device (e.g., a processing device).

In step 1040, the model training module 460 may generate a user behavior model by training the preliminary model based on the one or more user behaviors and the feature information. Each of the one or more classifiers may have an initial parameter related to the weight of the classifier. The initial parameter related to the weight of the classifier may be adjusted during the training of the preliminary model.

The feature information and the one or more user behaviors may constitute a training sample. The preliminary model may take the feature information as an input and may determine an internal output based on feature information. The model training module 460 may take the one or more user behaviors as a desired output. The model training module 460 may train the preliminary model to minimize a loss function. The model training module 460 may compare the internal output with the desired output in the loss function. For example, the internal output may correspond to an internal score; and the desired output may correspond to a desired score. The loss function may relate to a difference between the internal score and the desired score. Specifically, when the internal output is the same as the desired output, the internal score is the same as the desired score, and the loss function is at a minimum (e.g., zero). The minimization of the loss function may be iterative. The iteration of the minimization of the loss function may terminate when the value of the loss function is less than a predetermined threshold. The predetermined threshold may be set based on various factors, including the number of the training samples, the accuracy degree of the model, etc. The model training module 460 may iteratively adjust the initial parameters of the preliminary model during the minimization of the loss function. After minimizing the loss function, the initial parameters of the classifiers in the preliminary model may be updated and a trained user behavior model may be generated.

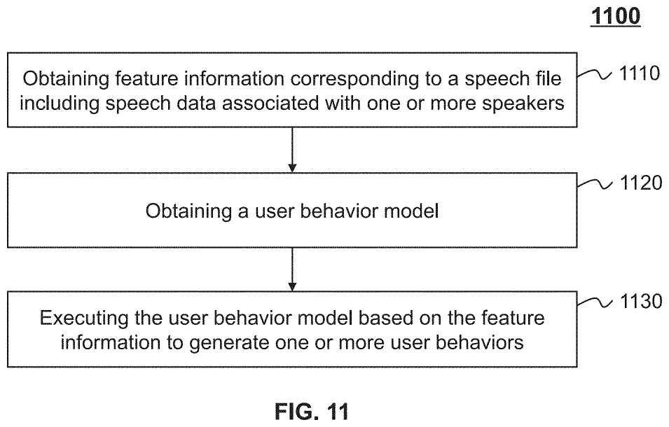

FIG. 11 is a flowchart illustrating an exemplary process for executing a user behavior model to generate user behaviors according to some embodiments of the present disclosure. In some embodiments, the process 1100 may be implemented in the on-demand service system 100 as illustrated in FIG. 1. For example, the process 1100 may be stored in the storage 150 and/or other storage (e.g., the ROM 230, the RAM 240) as a form of instructions, and invoked and/or executed by the server 110 (e.g., the processing engine 112 in the server 110, the processor 220 of the processing engine 112 in the server 110, the logic circuits of the server 110, and/or a corresponding module of the server 110). The present disclosure takes the modules of the server 110 as an example to execute the instruction.

In step 1110, the user behavior determination module 470 may obtain feature information corresponding to a speech file. The speech file may be a speech file that includes a conversation between multiple speakers. The speech file may be different from the sample speech file described elsewhere in the present disclosure. The feature information corresponding to the speech file may include a plurality of text segments and speaker identification information of the one or more speakers. In some embodiments, the processor 220 may generate the feature information as described in FIG. 6 and send it to the user behavior determination module 470. In some embodiments, the user behavior determination module 470 may obtain the feature information from the storage 150. The feature information obtained from the storage 150 may be obtained from the processor 220 or may be obtained from an external device (e.g., a processing device).

In step 1120, the user behavior determination module 470 may obtain a user behavior model. In some embodiments, the user behavior model may be trained by the model training module 460 in process 1000.

The user behavior model may include a Ranking Support Vector Machine (SVM) model, a Gradient Boosting Decision Tree (GBDT) model, a LambdaMART model, an adaptive boosting model, a recurrent neural network model, a convolutional network model, a hidden Markov model, a perceptron neural network model, a Hopfield network model, a self-organizing map (SOM), or a learning vector quantization (LW)), or the like, or any combination thereof. The recurrent neural network model may include a long short term memory (LSTM) neural network model, a hierarchical recurrent neural network model, a bi-direction recurrent neural network model, a second-order recurrent neural network model, a fully recurrent network model, an echo state network model, a multiple timescales recurrent neural network (MTRNN) model, etc.

In step 1130, the user behavior determination module 470 may execute the user behavior model based on the feature information to generate one or more user behaviors. The user behavior determination module 470 may input the feature information into the user behavior model. The user behavior model may determine one or more user behaviors based on the one or more inputted feature information.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A non-transitory computer readable signal medium may include a propagated data signal with computer readable program code embodied therein, for example, in baseband or as part of a carrier wave. Such a propagated signal may take any of a variety of forms, including electromagnetic, optical, or the like, or any suitable combination thereof. A computer readable signal medium may be any computer readable medium that is not a computer readable storage medium and that may communicate, propagate, or transport a program for use by or in connection with an instruction execution system, apparatus; or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed subject matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1-11. (canceled)

12. A method implemented on a speech recognition device having at least one input port configured to connect one or more microphones to detect one or more speech, at least one storage device storing a set of instructions for speech recognition, and at least one logic circuits in communication with the at least one storage device, the method comprising:
obtaining, by the logic circuits, an audio file including speech data associated with one or more speakers from the one or more microphones via the input port;
separating, by the logic circuits, the audio file into one or more audio sub-files that each includes a plurality of speech segments, wherein each of the one or more audio sub-files corresponds to one of the one or more speakers;
obtaining, by the logic circuits, time information and speaker identification information corresponding to each of the plurality of speech segments;
converting, by the logic circuits, the plurality of speech segments to a plurality of text segments, wherein each of the plurality of speech segments corresponds to one of the plurality of text segments; and
generating, by the logic circuits, first feature information based on the plurality of text segments, the time information, and the speaker identification information.

13. The method of claim 12, wherein the one or more microphones are mounted in at least one vehicle compartment and the method further including:
obtaining, by the logic circuits, location information of the at least one vehicle compartment, wherein the location information of the at least one vehicle compartment is determined by a global positioning system (GPS) chipset mounted on the at least one vehicle compartment; and
generating, by the logic circuits, the first feature information based on the plurality of text segments, the time information, the speaker identification information, and the location information of the at least one vehicle compartment.

14. The method of claim 12, wherein the audio file is obtained from a single channel, and the separating the audio file into one or more speech sub-files further includes performing a speech separation including a computational auditory scene analysis, or a blind source separation.

15. The method of claim 12, wherein the time information corresponding to each of the plurality of speech segments includes a starting time and a duration time of the speech segment.

16. The method of claim 12, further comprising:
obtaining, by the logic circuits, a preliminary model;
obtaining, by the logic circuits, one or more user behaviors that each corresponds to one of the one or more speakers; and
generating, by the logic circuits, a user behavior model by training the preliminary model based on the one or more user behaviors and the generated first feature information.

17. The method of claim 16, further comprising:
obtaining, by the logic circuits, second feature information; and
executing, by the logic circuits, the user behavior model based on the second feature information to generate one or more user behaviors.

18-19. (canceled)

20. The method of claim 12, further comprising:
segmenting, by the logic circuits, each of the plurality of text segments into words after converting each of the plurality of speech segments to a text segment.

21. The method of claim 12, wherein the generating, by the logic circuits, the first feature information based on the plurality of text segments, the time information, and the speaker identification information further includes:
sequencing, by the logic circuits, the plurality of text segments based on the time information of the text segments; and
generating, by the logic circuits, the first feature information by labelling each of the sequenced text segments with the corresponding speaker identification information.

22. The method of claim 12, further comprising:
obtaining, by the logic circuits, location information of the one or more speakers; and
generating, by the logic circuits, the first feature information based on the plurality of text segments, the time information, the speaker identification information, and the location information.

23. A non-transitory computer readable medium, comprising at least one set of instructions for speech recognition, wherein when executed by at least one processor of an electronic terminal, the at least one set of instructions directs the at least one processor to perform acts of:
obtaining an audio file including speech data associated with one or more speakers;
separating the audio file into one or more audio sub-files that each includes a plurality of speech segments, wherein each of the one or more audio sub-files corresponds to one of the one or more speakers;
obtaining time information and speaker identification information corresponding to each of the plurality of speech segments;
converting the plurality of speech segments to a plurality of text segments, wherein each of the plurality of speech segments corresponds to one of the plurality of text segments; and
generating first feature information based on the plurality of text segments, the time information, and the speaker identification information.

24. (canceled)

25. A speech recognition system, comprising:
a bus;
at least one input port connected to the bus;
one or more microphones connected to the input port, each of the one or more microphones configured to detect speech from at least one of one or more speakers and generate speech data of the corresponding speaker to the input port;
at least one storage device connected to the bus, storing a set of instructions for speech recognition; and
logic circuits in communication with the at least one storage device, wherein when executing the set of instructions, the logic circuits are directed to:
obtain an audio file including the speech data associated with the one or more speakers;
separate the audio file into one or more audio sub-files that each includes a plurality of speech segments, wherein each of the one or more audio sub-files corresponds to one of the one or more speakers;
obtain time information and speaker identification information corresponding to each of the plurality of speech segments;
convert the plurality of speech segments to a plurality of text segments, wherein each of the plurality of speech segments corresponds to one of the plurality of text segments; and
generate first feature information based on the plurality of text segments, the time information, and the speaker identification information.

26. The system of claim 25, wherein the one or more microphones are mounted in at least one vehicle compartment.

27. The system of claim 25, wherein the audio file is obtained from a single channel, and to separate the audio file into one or more audio sub-files, the logic circuits are directed to perform a speech separation including at least one of a computational auditory scene analysis or a blind source separation.

28. The system of claim 25, wherein the time information corresponding to each of the plurality of speech segments includes a starting time and a duration time of the speech segment.

29. The system of claim 25, wherein the logic circuits are further directed to:
obtain a preliminary model;
obtain one or more user behaviors that each corresponds to one of the one or more speakers; and
generate a user behavior model by training the preliminary model based on the one or more user behaviors and the generated first feature information.

30. The system of claim 29, wherein the logic circuits are further directed to:
obtain second feature information; and
execute the user behavior model based on the second feature information to generate one or more user behaviors.

31-32. (canceled)

33. The system of claim 25, wherein the logic circuits are further directed to:
segment each of the plurality of text segments into words after converting each of the plurality of speech segments to a text segment.

34. The system of claim 25, wherein to generate the first feature information based on the plurality of text segments, the time information, and the speaker identification information, the logic circuits are directed to:
sequence the plurality of text segments based on the time information of the text segments; and
generate the first feature information by labelling each of the sequenced text segments with the corresponding speaker identification information.

35. The system of claim 25, wherein the logic circuits are further directed to:
obtain location information of the one or more speakers; and
generate the first feature information based on the plurality of text segments, the time information, the speaker identification information, and the location information.

36. The system of claim 26, wherein the logic circuits are further directed to:
obtain location information of the at least one vehicle compartment, wherein the location information of the at least one vehicle compartment is determined by a global positioning system (GPS) chipset mounted on the at least one vehicle compartment; and
generate the first feature information based on the plurality of text segments, the time information, the speaker identification information, and the location information of the at least one vehicle compartment.
